(19) United States
(12) Patent Application Publication
(10) Pub. No.: US 2026/0250865 A1
(43) Pub. Date: Aug. 27, 2026

(54) WATER ELECTROLYSIS CATALYSTS FOR USE IN RENEWABLE ENERGY SYSTEMS

(71) Applicant: University of Houston System, Houston, TX (US)

(72) Inventors: Zhifeng Ren, Pearland, TX (US); Minghui Ning, Houston, TX (US)

(73) Assignee: University of Houston System, Houston, TX (US)

(21) Appl. No.: 19/489,711

(22) PCT Filed: Jun. 6, 2024
(86) PCT No.: PCT/US2024/032790

§ 371 Date: Dec. 3, 2025

Related U.S. Application Data
(60) Provisional application No. 63/472,163, filed on Jun. 9, 2023.

(51) Int. Cl. C25B 11/061; C25B 11/031; C25B 11/052; C25B 11/065; C25B 11/081

(52) U.S. Cl. CPC C25B 11/061; C25B 11/031; C25B 11/052; C25B 11/065; C25B 11/081

(57) ABSTRACT

A method of preparing a water electrolysis catalyst includes subjecting at least a portion of a substrate to a temperature of from about 400° C. to about 1500° C. for a time period of from about 5 seconds to about 30 minutes to form a heat-treated substrate; contacting the heat-treated substrate with a fluid comprising a transition metal salt under conditions suitable for formation of the water electrolysis catalyst wherein the catalyst has an overpotential ranging from about 100 mV to about 1000 mV in a water electrolysis reaction at a current density of 500 mA/cm².

### CROSS-REFERENCE TO RELATED APPLICATIONS

This application is a 35 U.S.C. § 371 national stage application of PCT/US2024/032790 filed Jun. 6, 2024 and entitled “Water Electrolysis Catalysts for Use in Renewable Energy Systems,” which claims priority to U.S. Provisional Application Ser. No. 63/472,163 filed Jun. 9, 2023 and entitled “CATALYSTS FOR USE IN RENEWABLE ENERGY SYSTEMS,” each of which is hereby incorporated herein by reference in its entirety for all purposes.

### TECHNICAL FIELD

The present disclosure relates generally to renewable energy. More particularly, the present disclosure relates to catalysts for use in renewable energy platforms.

### BACKGROUND

Sustainable hydrogen production is a contemporary topic until our demand for energy ends. Water electrolysis using renewable energy sources such as electrical power from grids, solar, and wind energy is one of the alternative technologies that can produce pure H₂. Water electrolysis refers to the splitting of water and its conversion into hydrogen (H₂) and oxygen (O₂). From the chemical perspective, water electrolysis includes two half-reactions, specifically, a Hydrogen Evolution Reaction (HER): 2H⁺+2 e⁻→H₂ and an Oxygen Evolution Reaction (OER): 2H₂O→O₂+4H⁺+4e⁻.

The efficiency of hydrogen generation relies on the breakage of O—H bonds in water, the formation of H—H bonds of a hydrogen molecule and the formation of O—O bond of an oxygen molecule. Use of electricity to break the chemical bonds in the presence of a catalyst, for example, an electrocatalytic strategy, has to subdue the overpotential arising due to the activation energy barrier and initiate the chemical reaction in order to be effective. Though a few precious metals and their compounds can be used as catalysts providing relatively low overpotential for the water splitting reaction, a low natural abundance of these precious metals restricts their utility for large-scale applications.

Due to their high conductivity, corrosion resistance, and mechanical strength, various types of stainless steels have been exploited in the fields of petrochemical, aviation, industrial construction, and catalysis as conductive substrates or current collectors. However, due to the lack of active species on the surface, the electrocatalytic potential of stainless-steel is believed to provide limited performance. As such, an ongoing need exists to develop electrocatalysts that overcome the aforementioned challenges.

### SUMMARY

Disclosed herein is a method of preparing a water electrolysis catalyst comprising subjecting at least a portion of a substrate to a temperature of from about 400° C. to about 1500° C. for a time period of from about 5 seconds to about 30 minutes to form a heat-treated substrate; contacting the heat-treated substrate with a fluid comprising a transition metal salt under conditions suitable for formation of the water electrolysis catalyst wherein the catalyst has an overpotential ranging from about 100 mV to about 1000 mV in a water electrolysis reaction at a current density of 500 mA/cm².

Also disclosed herein is a method of preparing a water electrolysis catalyst comprising subjecting at least a portion of a substrate to a temperature of from about 400° C. to about 1500° C. for a time period of from about 5 seconds to about 30 minutes to form a heat-treated substrate wherein the substrate is selected from the group consisting of an Austentitic stainless steel, a ferritic stainless steel, a Martensitic stainless steel, a duplex (Ferritic-Austenitic) stainless steel, a precipitation hardening stainless steel and combinations thereof; contacting the heat-treated substrate with a fluid comprising a transition metal salt under conditions suitable for formation of the water electrolysis catalyst having an overpotential ranging from about 100 mV to about 1000 mV in a water electrolysis reaction at a current density of 500 mA/cm².

### BRIEF DESCRIPTION OF THE FIGURES

The following figures form part of the present specification is included to further demonstrate certain aspects of the present disclosure. The subject matter of the present disclosure may be better understood by reference to the figure in combination with the detailed description of specific aspects presented herein.

FIG. 1A depicts a schematic diagram of a heat-treated precursor activation process according to one or more aspects disclosed herein.

FIG. 1B is a scanning electron micrograph of the stainless steel mat (SSM) of Example 1.

FIG. 1C is a scanning electron micrograph of the high-temperature annealed SSM of Example 1.

FIG. 1D is a scanning electron micrograph of nickel-containing stainless steel mat (Ni-SSM) after quenching.

FIG. 1E is the scanning electron micrograph area for X-ray dispersive spectroscopy mapping of the Ni-SSM of Example 1.

FIG. 1F is the result of X-ray dispersive spectroscopy mapping of an area of the Ni-SSM of Example 1.

FIG. 1G is the result of X-ray dispersive spectroscopy mapping for iron of an area of the Ni-SSM of Example 1.

FIG. 1H is the result of X-ray dispersive spectroscopy mapping for chromium of an area of the Ni-SSM of Example 1.

FIG. 1I is the result of X-ray dispersive spectroscopy mapping for nickel of an area of the Ni-SSM of Example 1.

FIG. 1J is the result of X-ray dispersive spectroscopy for molybdenum mapping of an area of the Ni-SSM of Example 1.

FIG. 1K is the result of X-ray dispersive spectroscopy mapping for oxygen of an area of the Ni-SSM of Example 1.

FIG. 2A depict the X-ray diffraction patterns of the SSM and Ni-SSM of Example 1.

FIG. 2B is the X-ray photoelectron spectra of iron in the SSM and Ni-SSM of Example 1.

FIG. 2C is the X-ray photoelectron spectra of nickel in the SSM and Ni-SSM of Example 1.

FIG. 2D is the X-ray photoelectron spectra of chromium in the SSM and Ni-SSM of Example 1.

FIG. 2E is the X-ray photoelectron spectra of molybdenum in the SSM and Ni-SSM of Example 1.

FIG. 2F is the X-ray photoelectron spectra of oxygen in the SSM and Ni-SSM of Example 1.

FIG. 3A is a plot of the current density as a function of potential for the indicated electrodes in a hydrogen evolution reaction (HER).

FIG. 3B is a plot of the HER Tafel slopes for the indicated electrodes.

FIG. 3C is a plot of the current density as a function of potential the Ni-SSM before and after 10,000 cyclic voltammetry scans in a HER.

FIG. 3D is a plot of the current density as a function of potential for the indicated electrodes in an oxygen evolution reaction (OER).

FIG. 3E is a plot of the Tafel slopes for the indicated electrodes in an OER.

FIG. 3F is a plot of the current density as a function of potential Ni-SSM before and after 10,000 cyclic voltammetry scans in an OER.

FIG. 3G depicts electrochemical impedance spectroscopy measurements for the indicated electrodes.

FIG. 3H is a graph of potential over time for a Ni-SSM at 500 mA/cm² in 1 M KOH.

FIG. 4A is a plot of current density as a function of voltage for the indicated catalysts.

FIG. 4B is a bar graph of the voltage for the indicated catalysts.

FIG. 4C is a plot of current density as a function of voltage at the indicated KOH concentration and temperature.

FIG. 4D is a graph of the voltage as a function of time at either 25° C. or 60° C. at 100 mA cm⁻² and 6 M KOH.

### DETAILED DESCRIPTION

Disclosed herein are electrocatalysts and methods of using the same, as well as compositions and methods for the formation of the electrocatalysts. In one or more aspects, the compositions and methods disclosed herein result in an increased number of species on the surface of a material that allows that material to function as a catalyst in a hydrogen evolution reaction, an oxygen evolution reaction or both. Herein, these materials are collectively termed water electrolysis catalysts (WEC).

In one or more aspects, a method of preparing a WEC comprises activating a surface of a substrate that will be used as the WEC. Herein the substrate that is subjected to the methods and compositions disclosed herein is termed a precursor. A precursor suitable for activation is characterized as exhibiting a relatively high surface area and/or as exhibiting a relatively high catalytic activity in water electrolysis. For example, in some aspects, the precursor may be characterized by a surface area ranging from about 100 cm²/g to about 100000 cm²/g, additionally or alternatively, from about 100 cm²/g to about 10000 cm²/g, additionally or alternatively, from about 100 cm²/g to about 1000 cm²/g; additionally, or alternatively, the surface area may be at least about 100 cm²/g, at least about 150 cm²/g, at least about 200 cm²/g, at least about 250 cm²/g, or at least about 300 cm²/g, and/or not more than about 100000 cm²/g, not more than about 50000 cm²/g, not more than about 10000 cm²/g, not more than about 5000 cm²/g, or not more than about 1000 cm²/g.

A precursor may be characterized by a high catalytic activity as measured by the precursor's overpotential in a water electrolysis reaction. Due to the kinetic barrier for the reaction, water electrolysis requires a higher potential than thermodynamic potential (1.23 V) to overcome the kinetic barrier. The excess potential is also known as overpotential (n) which results from the intrinsic activation barriers present on both anode and cathode. In one or more aspects, at a current density of 500 mA cm⁻² the overpotential of a precursor may range from about 10 mV to about 1000 mV, alternatively from about 30 mV to about 600 mV or alternatively from about 100 mV to about 300 mV. A precursor may be any material compatible with the other components of the WEC and having the characteristics disclosed herein.

In one or more aspects, the precursor comprises a metallic alloy, a metallic foil, a metallic stock, a metallic foam, a metallic mat or a metallic mesh. Herein mesh generally refers to a weaved structure of metal wire or metal wire bundles. Foam generally refers to a structure in which up to 95% of the material is taken out so that it is highly porous with high surface area. Herein a metal foam refers to a material or structure consisting of a solid metal with gas-filled pores comprising a large portion of the volume. The pores can be sealed (closed-cell foam) or interconnected (open-cell foam).

In addition, nonlimiting examples of the precursor include a metal mesh, and nonlimiting examples of the metal to be used include gold, silver, platinum, nickel, titanium and chromium. In addition, nonlimiting examples of a metal oxide which is used for the metal oxide precursor include indium oxide, tin oxide, tin-doped indium oxide, and fluorine-doped tin oxide. In some aspects, the precursor comprises a metal foam, such as a nickel foam, or a metal alloy foam. In one or more aspects, the precursor comprises a nickel mesh, a tungsten mesh, a titanium mesh, an iron mesh, a stainless steel mesh, meshes comprised of alloys of metals such as platinum, rhenium, nickel, tungsten and iron. In one or more aspects, the precursor is a porous material.

In one or more aspects, the precursor comprises stainless steel. Herein stainless steel refers to alloys of iron with other metals that are resistant to rusting and corrosion and are generally comprised of (i) equal to or greater than about 10.5% chromium, and (ii) equal to or less than about 1.2 wt. % carbon.

In one or more aspects, the stainless steel precursor comprises an Austentitic stainless steel, a ferritic stainless steel, a Martensitic stainless steel, a duplex (Ferritic-Austenitic) stainless steel, a precipitation hardening stainless steel or combinations thereof. Herein Austenitic stainless steel refers to a stainless steel that is nonmagnetic with a carbon content ranging from about 0.2 wt. % to about 1.0 wt. % and a chromium content ranging from about 10.5 wt. % to about 18 wt. %. Herein ferritic stainless steels refers to magnetic stainless steels that are essentially nickel-free, and contain between 12.5 wt. % and 17 wt. % chromium. Herein Martensitic stainless steels refer to stainless steels characterized by tensile strengths ranging from about 900 Mega Pascals (MPa) to about 1600 MPa. Herein duplex (Ferritic-Austenitic) stainless steels refer to stainless steels that are half austenite and half delta-ferrite, have a chromium content ranging from about 18 wt. % to about 26 wt. %, a nickel content ranging from about 4 wt. % to about 7 wt. %, molybdenum, when present, in amounts equal to or less than about 4%, and optionally copper. Herein precipitation-hardening stainless steels refer to stainless steels having iron alloyed with copper, aluminum, titanium, niobium, molybdenum or combinations thereof. Precipitation-hardening stainless steels may be further characterized by tensile strengths ranging from about 850 MPa to about 1700 MPa and yield strengths of ranging from about 520 MPa to greater than about 1500 MPa.

In one or more aspects, a method for the activation of a precursor to form an electrocatalyst comprises heat treating the precursor. Heat treatment of the precursor may be carried out using any suitable methodology. For example, the precursor may be heat treated by exposure to a torch or laser or by being disposed within a heating device such as a furnace.

The precursor may be heat treated by exposing the material to temperatures equal to or greater than about 400° C., alternatively equal to or greater than about 600° C., alternatively equal to or greater than about 800° C., alternatively equal to or greater than about 1000° C. or alternatively from about 400° C. to about 1500° C. Heat treatment of the precursor may occur for a period of time ranging from about 5 seconds to about 1800 seconds, alternatively from about 5 seconds to about 60 seconds or alternatively from about 5 seconds to about 30 seconds.

In one or more aspects, the entire precursor is heat treated. In other aspects, a portion of the precursor is heat treated. It is contemplated in one or more aspects, heat treatment of the precursor may be carried out in a plurality of stages such as for a first period of time at a first temperature, followed by a ramp to a second temperature which is held for a second period of time.

In one or more aspects, heat treating of the precursor may be carried out in an oxidizing atmosphere such as in the presence of oxygen or air. Subsequent to heat treating the precursor is termed a heat-treated precursor. Without wishing to be limited by theory, heat treating of the precursor is carried out to anneal the material. Annealing refers to a heat treatment that alters the physical and sometimes chemical properties of a material to increase its ductility and reduce its hardness. Annealing involves heating a material above its recrystallization temperature for a period of time before cooling for a time period.

A method of the present disclosure may further comprise contacting the heat-treated precursor with a fluid comprising a transition metal salt. For simplicity, the fluid comprising a transition metal salt is designated as TMS. In one or more aspects, the TMS comprises an aqueous fluid such as water or deionized water.

In one or more aspects, the transition metal salt of the TMS comprises any metal capable of catalyzing water electrolysis. Generally, the transition metal salt has the formula MX_{P} where M is a cationic transition metal and X is an anionic ligand, present in any number, p, suitable to form a neutral salt. In one or more aspects, the transition metal salt comprises a Group 3 transition metal, a Group 4 transition metal, a Group 5 transition metal, a Group 6 transition metal, a Group 7 transition metal, a Group 8 transition metal, a Group 9 transition metal, a Group 10 transition metal, a Group 11 transition metal, a Group 12 transition metal, or combinations thereof.

The metal atom of the transition metal salt can have any positive oxidation state available to the metal atom. For example, the transition metal can have an oxidation state of from +2 to +6; additionally or alternatively, from +2 to +4; or, additionally or alternatively, from +2 to +3. In one or more aspects, the transition metal salt comprises nickel (Ni), iron (Fe), molybdenum (Mo), manganese (Mn), or combinations thereof. X may be any monoatomic or polyatomic anion. In one or more aspects, X comprises a halide, a carboxylate, a β-diketonate, a hydrocarboxide, a nitrate, a carbonate, a nitrate, or combinations thereof.

In one or more aspects, the heat-treated precursor is contacted with the MS. Contacting of the heat treated precursor and the TMS may be made using any suitable methodology such as immersion of the heat-treated precursor in the TMS or spraying of the TMS onto the precursor.

In one or more aspects, the heat-treated precursor and TMS are contacted under conditions that allow for a portion of the transition metal in the TMS to become associated with the precursor such as through bond formation. For example, the heat-treated precursor may be contacted with the TMS for a time period of from about 0.1 minute to about 1 hour, additionally or alternatively, from about 1 minutes to about 1 hour or, additionally or alternatively, for less than about 15 minutes. In one or more aspects, the heat-treated precursor may be contacted with TMS under ambient conditions, for example, room temperature and about one atmosphere pressure. In one or more aspects, the heat-treated precursor is contacted with the TMS immediately (e.g., less than about 5 seconds) after heat treating the precursor. Contacting of the heat-treated precursor with the TMS may be carried out for a plurality of times, for example for at least 2 times, alternatively for at least 3 times, alternatively for at least 4 times, alternatively for at least 5 times or alternatively for from 2 times to 5 times.

The heat-treated precursor once contacted with the TMS may have an amount of transition metal associated with the precursor (e.g., surface of the precursor) from about 1×10⁻⁶ wt. % to about 10 wt. %, alternatively from about 1×10⁻⁶ wt. % to about 0.01 wt. %, alternatively from about 0.01 wt. % to about 1 wt. % or alternatively from about 1 wt. % to about 10 wt. % based on the total weight of the heat-treated precursor. The resultant material is a WEC.

The WEC may be associated with one or more electrodes in an electrocatalytic device using any suitable methodology. For example, an electrode composition and the WEC may be contacted under conditions suitable to associate the electrode and WEC.

In one or more aspects, a precursor subjected to the compositions and methods disclosed herein is characterized by an increased catalytic activity. Herein, unless indicated otherwise, reference to catalytic activity refers to the ability of a material to catalyze a water electrolysis reaction (HER, OER or both). The catalytic activity of the WEC may be increased when compared to the catalytic activity of the precursor prior to heat treatment and contact with a TMS. Any suitable methodology may be used to assess catalytic activity. For example, the catalytic activity may be assessed by the overpotential.

In one or more aspects, the WEC has a current density of about 500 millampere per square centimeter (mA/cm²) with an overpotential of from about 10 mV to about 1000 mV, additionally or alternatively, from about 30 mV to about 600 mV or, additionally or alternatively, from about 100 mV to about 300 mV. In one or more aspects, the catalytic activity of the WEC, designated A, is greater than the catalytic activity of the precursor, designated B, by equal to or greater than about 10%, alternatively equal to or greater than about 25%, alternatively equal to or greater than about 50% or alternatively from about 10% to about 50%.

In one or more aspects, the WEC has a Tafel slope of from about 20 milliVolts per decade (mV/dec) to about 200 mV/dec, additionally or alternatively, from about 20 mV/dec to about 100 mV/dec or, additionally or alternatively, from about 20 mV/dec to about 60 mV/dec. The Tafel slope, is related to the activation energy of the reaction and indicates the charge transfer kinetics of the electrochemical reaction. Generally, the steeper the slope or the higher the Tafel slope, the higher the activation energy required for the reaction to occur and the slower the reaction rate.

Advantageously, the presently disclosed methods represent a universal and one-step activation of a precursor (e.g., stainless steel) for producing an efficient and stable water electrolysis catalyst.

### ADDITIONAL DISCLOSURE

The following are exemplary aspects of the subject matter disclosed herein:

A first aspect which is a method of preparing a water electrolysis catalyst comprising subjecting at least a portion of a substrate to a temperature of from about 400° C. to about 1500° C. for a time period of from about 5 seconds to about 30 minutes to form a heat-treated substrate contacting the heat-treated substrate with a fluid comprising a transition metal salt under conditions suitable for formation of the water electrolysis catalyst wherein the substrate has an overpotential ranging from about 100 mV to about 1000 mV in a water electrolysis reaction at a current density of 500 mA/cm².

A second aspect which is the method of the first aspect wherein the substrate has a surface area ranging from about 100 cm²/g to about 1000 cm²/g.

A third aspect which is the method of any of the first through second aspects wherein the substrate at a current density of 500 mA cm⁻² has an overpotential ranging from about 100 mV to about 1000 mV for a water electrolysis reaction.

A fourth aspect which is the method of any of the first through third aspects wherein the substrate comprises a metallic alloy, a metallic foil, a metallic stock, a metallic foam, a metallic mat or a metallic mesh or combinations thereof.

A fifth aspect which is the method of any of the first through fourth aspects wherein the substrate comprises a nickel mesh, a tungsten mesh, a titanium mesh, an iron mesh, a stainless-steel mesh, a stainless steel mat or combinations thereof.

A sixth aspect which is the method of any of the first through fifth aspects wherein the substrate comprises an Austentitic stainless steel, a ferritic stainless steel, a Martensitic stainless-steel, a duplex (Ferritic-Austenitic) stainless steel, a precipitation hardening stainless-steel or combinations thereof.

A seventh aspect which is the method of any of the first through sixth aspects wherein the conditions suitable for formation of the water electrolysis catalyst include an oxidizing atmosphere.

An eighth aspect which is the method of any of the first through seventh aspects wherein the fluid comprising a transition metal salt is an aqueous fluid.

A ninth aspect which is the method of any of the first through eighth aspects wherein the transition metal salt has the formula MX_{P}, where M is a cationic transition metal, X is an anionic ligand, and p is any number to form a neutral salt.

A tenth aspect which is the method of any of the first through ninth aspect wherein the transition metal salt comprises a Group 3 transition metal, a Group 4 transition metal, a Group 5 transition metal, a Group 6 transition metal, a Group 7 transition metal, a Group 8 transition metal, a Group 9 transition metal, a Group 10 transition metal, a Group 11 transition metal, a Group 12 transition metal, or combinations thereof.

An eleventh aspect which is the method of the ninth aspect wherein the cationic transition metal has an oxidation state of from +2 to +6.

A twelfth aspect which is the method of any of the first through eleventh aspects wherein the transition metal salt comprises nickel (Ni), iron (Fe), molybdenum (Mo), manganese (Mn) or combinations thereof.

A thirteenth aspect which is the method of the ninth aspect wherein X is a monoatomic anion or a polyatomic anion.

A fourteenth aspect which is the method of the ninth aspect wherein X comprises a halide, a carboxylate, a β-diketonate, a hydrocarboxide, a nitrate, a carbonate, a nitrate, or combinations thereof.

A fifteenth aspect which is the method of any of the first through fourteenth aspects wherein the water electrolysis catalyst has an amount of transition metal ranging from about 1×10⁻⁶ wt. % to about 10 wt. % based on the total weight of the water electrolysis catalyst.

A sixteenth aspect which is the method of any of the first through fifteenth aspects wherein the water electrolysis catalyst has a Tafel slope of from about 30 milliVolts per decade (mV/dec) to about 240 mV/dec.

A seventeenth aspect which is a method of preparing a water electrolysis catalyst comprising subjecting at least a portion of a substrate to a temperature of from about 400° C. to about 1500° C. for a time period of from about 5 seconds to about 30 minutes to form a heat-treated substrate wherein the substrate is selected from the group consisting of an Austentitic stainless steel, a ferritic stainless steel, a Martensitic stainless steel, a duplex (Ferritic-Austenitic) stainless steel, a precipitation hardening stainless steel and combinations thereof; contacting the heat-treated substrate with a fluid comprising a transition metal salt under conditions suitable for formation of the water electrolysis catalyst having an overpotential ranging from about 100 mV to about 1000 mV in a water electrolysis reaction at a current density of 500 mA/cm².

An eighteenth aspect which is the method of the seventeenth aspect wherein the transition metal salt comprises nickel (Ni), iron (Fe), molybdenum (Mo), manganese (Mn) or combinations thereof.

A nineteenth aspect which is the method of any of the seventeenth through eighteenth aspects wherein the water electrolysis catalyst has an overpotential at a current density of 500 mA/cm² that is increased by equal to or greater than about 10% when compared to the overpotential of the substrate.

A twentieth aspect which is the method of any of the seventeenth through nineteenth aspects wherein the water electrolysis catalyst has a Tafel slope of from about 30 milliVolts per decade (mV/dec) to about 240 mV/dec.

### EXAMPLES

The following examples are given as particular aspects of the present disclosure and to demonstrate the practice and advantages thereof. It is understood that the examples are given by way of illustration and are not intended to limit the specification or the claims to follow in any manner.

### Example 1

For the preparation of Pt/C and IrO₂ electrode, A mixture of 60 μL Nafion, 540 μL ethanol, and 400 μL DI water was first prepared. 40 mg Pt/C was dispersed into the mixture via 10 mins sonication. Subsequently, a small piece of SSM was immersed into the mixture and sonicated for 30 mins to prepare the Pt/C electrode. For the IrO₂ electrode, 40 mg IrO₂ was dispersed into the mixture via 10 mins sonication, then a small piece of Ni foam was immersed into the mixture for 30 mins of sonication.

Nickel (II) nitrate hexahydrate [Ni(NO₃)₂·6H₂O, ≥97%, Sigma-Aldrich], cobalt (II) nitrate hexahydrate [Co(NO₃)₂·6H₂O, ≥98%, Sigma-Aldrich], iron (III) nitrate nonahydrate [Fe(NO₃)₃·6H₂O, 98.0-101.0%, Alfa Aesar], ethanol (C₂H₅OH, Decon Labs, Inc.), potassium hydroxide (KOH, 85%, pellets, ACS regent, Acros Organics), and hydrochloric acid (HCl, 36.5-38.0% w/w, Fisher Chemical) were used without further purification. Stainless steel mat (HA0209, Bekaert), stainless steel mesh (HA0206), Ni foam (thickness: 1.6 mm, porosity: ~95%), Fe foam (thickness: 1.5 mm, porosity: ~90%) were employed as electrodes. All electrodes were cleaned with 3 M HCl, ethanol, and deionized (DI) water several times before usage. DI water was used to prepare solutions unless otherwise specified.

For the quick high temperature annealing, a Bunsen burner with methane as fuel was employed as the heat source. The temperature of the flame is about 1200° C. Typically, a SSM with the size of 0.5×1.5 cm² was placed at the top of the Bunsen burner flame for 10-15 second until the SSM turned burning red. Then the heated SSM was cooled down naturally in the air and the high-temperature annealing (HT-SSM) was prepared.

### Preparation of Nickel Containing Stainless Steel Mat (Ni-SSM) and Other Activated Electrodes

For the activation of SSM, the same high temperature annealing was first employed to heat the SSM, then the heated SSM was immediately quenched in a 0.15 M Ni(NO₃)₂ aqueous solution for activation. The above process was repeated for three (3) times and the SSM was transformed from silver to uniform black color, then the SSM was completely activated. The same activation process was also applied to stainless steel mesh and Fe foam. For the activation of Ni foam, the same high temperature annealing was applied, while the quenching was conducted in 0.15 M Fe(NO₃)₃ aqueous solution. For comparison, the 0.15 M Ni(NO₃)₂ aqueous solution was replaced with DI water to study the influence of Ni²⁺ during the activation and the resulted electrode was denoted as DIW-SSM.

### Preparation of Pt/C and IrO₂ Electrode

A mixture of 60 μL NAFION™ 540 μL ethanol, and 400 μL DI water was first prepared. To prepare Pt/C electrode, 40 mg Pt/C was dispersed into the mixture via 10 mins sonication. Subsequently, a small piece of SSM was immersed into the mixture and sonicated for 30 mins to prepare the Pt/C electrode. For the IrO₂ electrode, 40 mg IrO₂ was dispersed into the mixture via 10 mins sonication, then a small piece of Ni foam was immersed into the mixture of 30 mins' sonication. Material characterizations

Scanning electron microscopy (SEM) images were obtained using a LEO 1525 SEM. X-ray diffraction (XRD) was conducted using a PANalytical X'pert PRO diffractometer with a Cu Ka radiation source. X-ray photoelectron spectroscopy (XPS) was performed using a PHI Quantera XPS scanning microprobe.

### Electrochemical Characterizations

Electrochemical tests were conducted on a Gamry Reference 600 electrochemical workstation. Three-electrode measurements were obtained with our sample (~0.5 cm×1.0 cm=~0.5 cm²), a graphite electrode, and a Hg/HgO electrode serving as working, counter, and reference electrodes, respectively. Cyclic voltammetry (CV) was performed at a scan rate of 2 mV/s with iR compensation (current-interrupt mode) unless specified otherwise. Potentials of the reference electrode were converted to the reversible hydrogen electrode (RHE) based on the following equation:

$${E}_{RHE} = {E}_{Hg / HgO} + 0.098 + 0.0591 \times pH . \qquad ( 1 )$$

The pH value of 1 M KOH was approximately 14.

### Example 2

### Material Synthesis and Characterizations

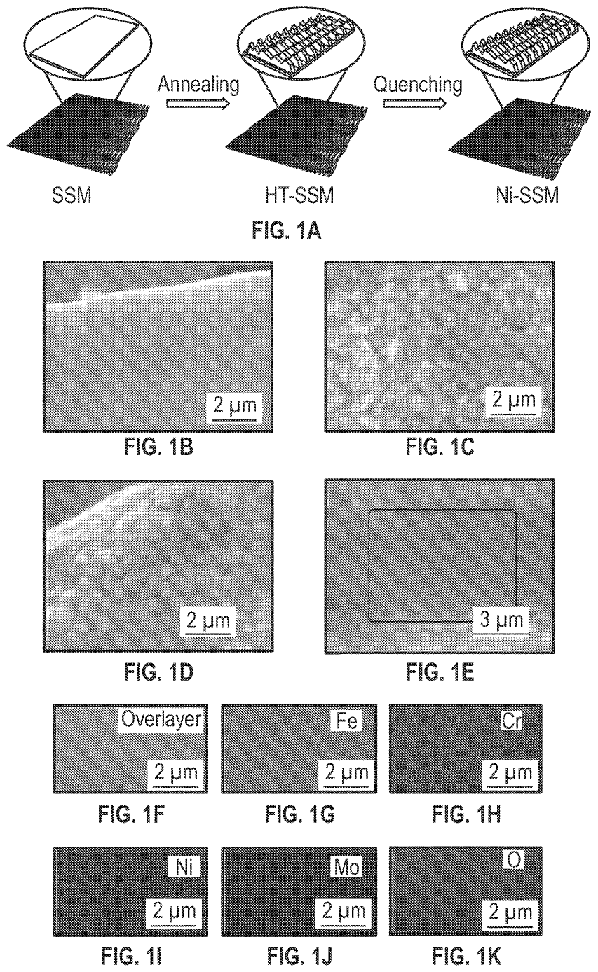

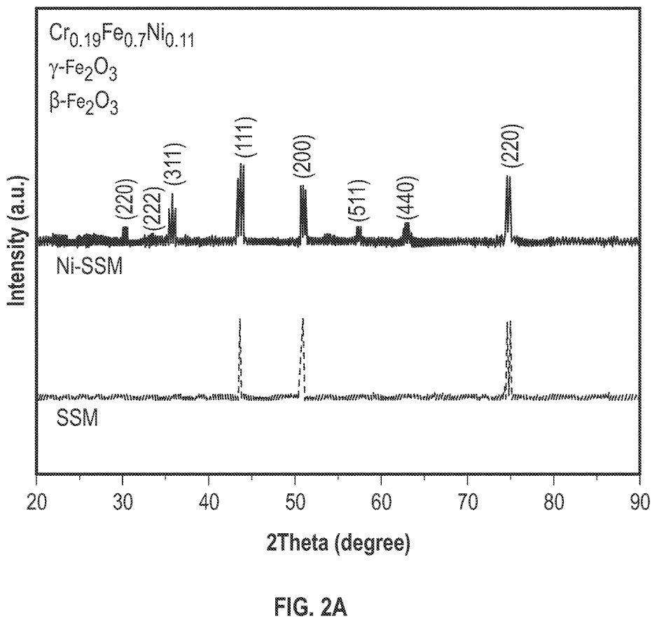

The SSM was activated via the one-step high temperature annealing and quenching as illustrated in FIG. 1A. Firstly, high temperature annealing was employed to completely heat the stainless steel. As shown in FIGS. 1B and 1C, the flat surface of SSM was transformed into a rough nanosheet architecture after the high temperature annealing. Right after the SSM was completely heated, it was immediately dropped into a Ni(NO₃)₂ aqueous solution for quenching. SEM image in FIG. 1D and S1 showed the Ni-SSM after quenching had a similar but smaller nanosheet morphology compared to the HT-SSM. The energy dispersive X-ray spectroscopy (EDS) measurements were collected on Ni-SSM to investigate the elemental composition and distribution. EDS mapping was conducted on the selective area as displayed in FIG. 1E and the corresponding results were given in FIGS. 1F-1K. The EDS mapping reveal the uniform distribution of all the elements on Ni-SSM. EDS point analysis showed the chemical composition of SSM, corresponding to the 316 type of stainless steel. After the high temperature annealing in air, the surface atomic percentage of O increased from 1.99% to 35.67%, while the Cr and Ni decreased from 20.39% and 8.29% to 4.63% and 1.96%, respectively. The surface of HT-SSM was oxidized after annealing and the main composition was iron oxide. The surface atomic percentage of O further increased to 41.66% after the quenching process in Ni(NO₃)₂ solution, while the Cr further decreased to 3.81%. Nonetheless, the atomic percentage of Ni increased to 2.66% after quenching in Ni(NO₃)₂ solution, which indicated Ni doping on the surface doped additional Ni onto the surface of the activated SSM.

### Example 3

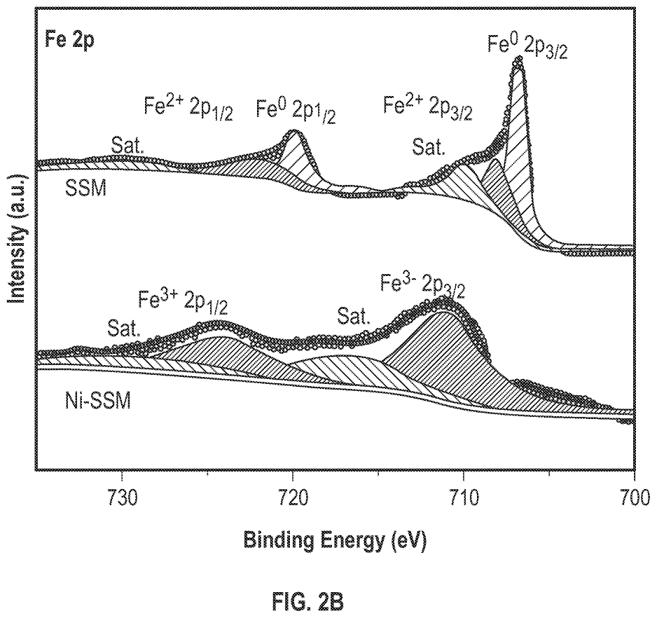

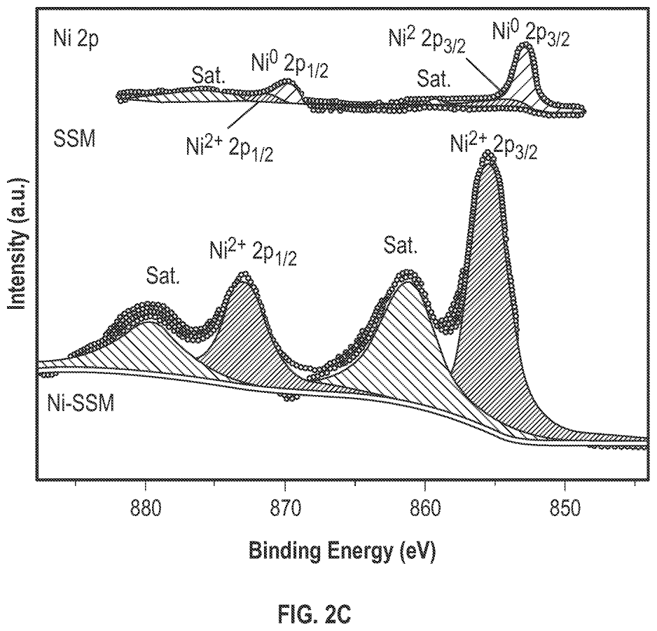

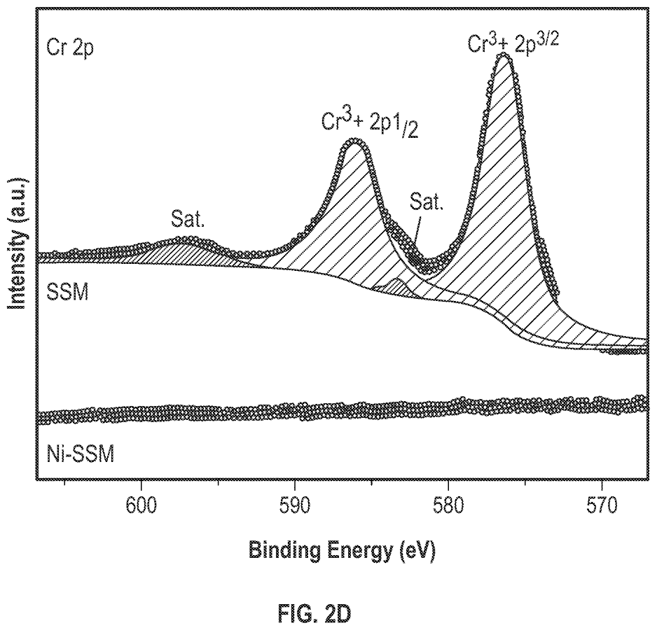

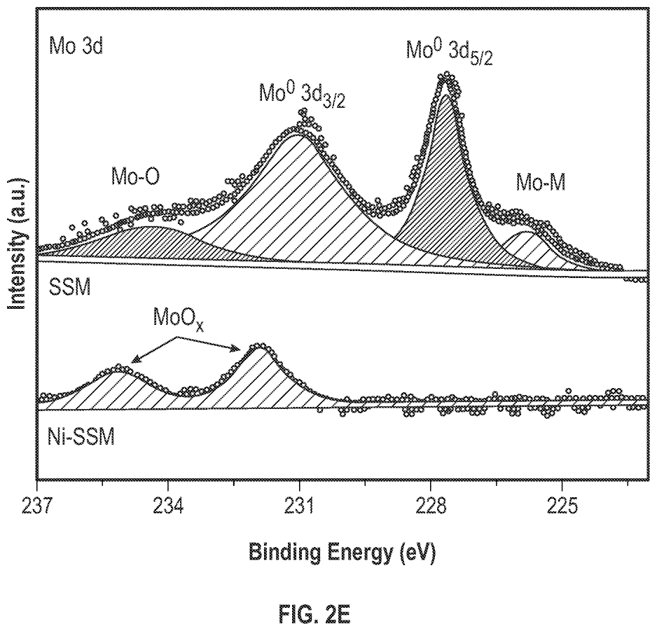

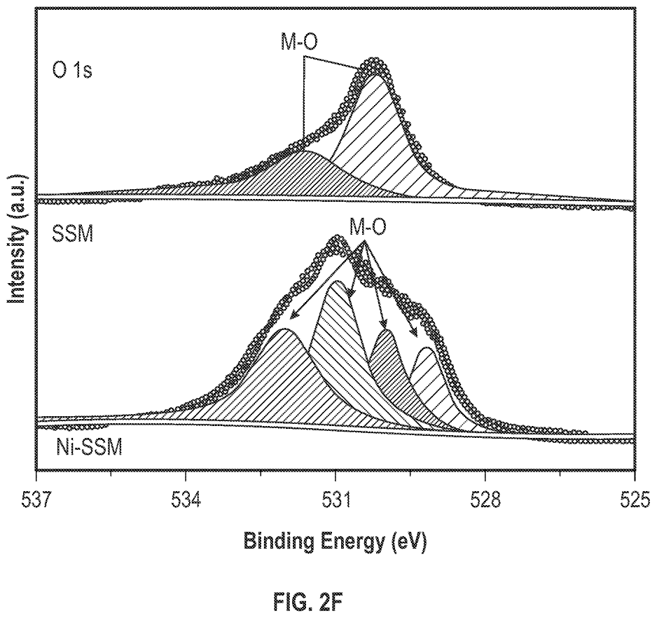

XRD patterns were analyzed to study the structure of SSM after different processing conditions were used. In FIG. 2A, the pristine SSM showed XRD peaks corresponding to Austenite Cr0.19Fe0.7Ni0.11 alloy (PDF #33-0397). After the high temperature annealing, the XRD peaks of Cr0.19Fe0.7Ni0.11 can still be observed and additional peaks corresponding to γ-Fe₂O₃ (PDF #39-1346) and β-Fe₂O₃ (PDF #39-0238) were discovered on the XRD pattern of HT-SSM. After quenched in DI water, the γ-Fe₂O₃ peaks of DIW-SSM became stronger while the β-Fe₂O₃ peaks of DIW-SSM became weaker when compared to HT-SSM. For Ni-SSM, the γ-Fe₂O₃ peaks became even stronger than DIW-SSM, while the β-Fe₂O₃ peaks almost disappeared as displayed in FIG. 2A. Combining EDS point analyses with XRD results, the main structure of all the SSM remained as Cr0.19Fe0.7Ni0.11 alloy, while the high temperature annealing generated γ-Fe₂O₃ and β-Fe₂O₃. The subsequent quenching process promoted the formation of γ-Fe₂O₃ and the quenching in the Ni(NO₃)₂ aqueous solution doped additional Ni onto Ni-SSM.

XPS was employed to investigate the surface composition of SSM before and after activation. The survey spectra showed that the elemental composition of SSM coincided with the EDS point analysis, while the Cr and Mo almost disappeared from the surface of Ni-SSM. FIG. 2B showed the Fe⁰ doublet at 706.8 and 719.8 eV and the Fe²⁺ doublet generated by mild surface oxidation at 708.0 and 721.6 eV. After activation, Fe³⁺ doublet can be observed at 711.0 and 724.0 eV. In FIG. 2C, the Ni⁰ of SSM doublet can be observed at 852.8 eV and 870.0 eV and the Ni²⁺ doublet at 853.6 eV and 871.3 eV can be attributed to the mildly oxidation at the surface. For Ni-SSM, the Ni²⁺ doublet at 855.5 eV and 873.0 eV revealed the oxidized valence state of Ni after activation. The Cr³⁺ doublet at 576.4 eV and 586.1 eV suggested the existence of Cr₂O₃ on the surface of SSM, which acted as the anti-corrosion layer for stainless steel. But after activation, no Cr peak can be discovered, and it is likely the formation of Fe₂O₃ completely covered the Cr element on the surface of Ni-SSM. The Mo 3d in FIG. 2E unveiled the metal state before activation and oxidized states after activation of Mo. The O 1s in FIG. 2F showed the existence of M-O bonds before and after activation and the O 1s displayed more peaks after activation, which suggested the complete oxidation at the surface of Ni-SSM. Therefore, the XPS results revealed that after activation, the surface of Ni-SSM was reconstructed into Ni doped Fe₂O₃. The XRD results proved the existence Fe₂O₃ (mainly γ-Fe₂O₃) and Cr0.19Fe0.7Ni0.11 alloy and the XPS results illustrated the formation of Ni doped Fe₂O₃ at the surface of Ni-SSM. These results indicate the surface of Ni-SSM was composed of Ni doped Fe₂O₃ while the core remained as the stainless steel alloy phase.

### Example 4

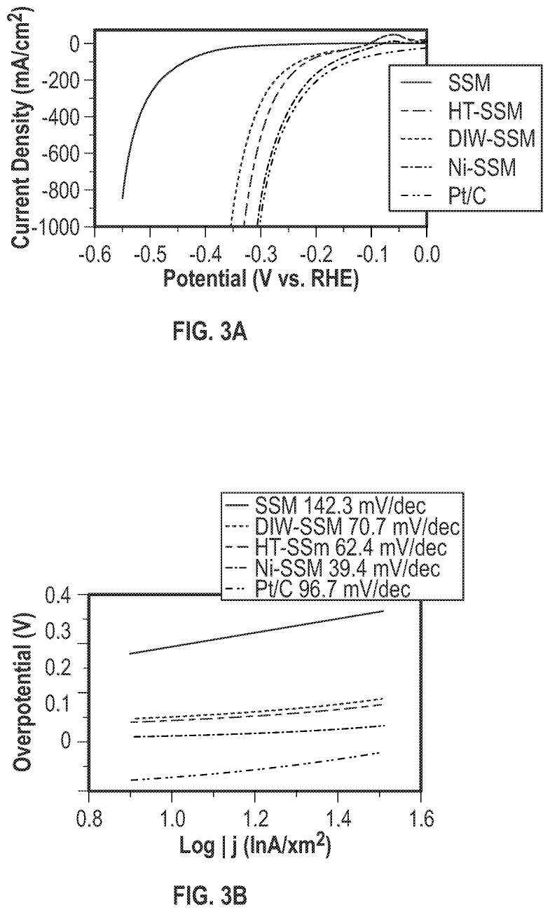

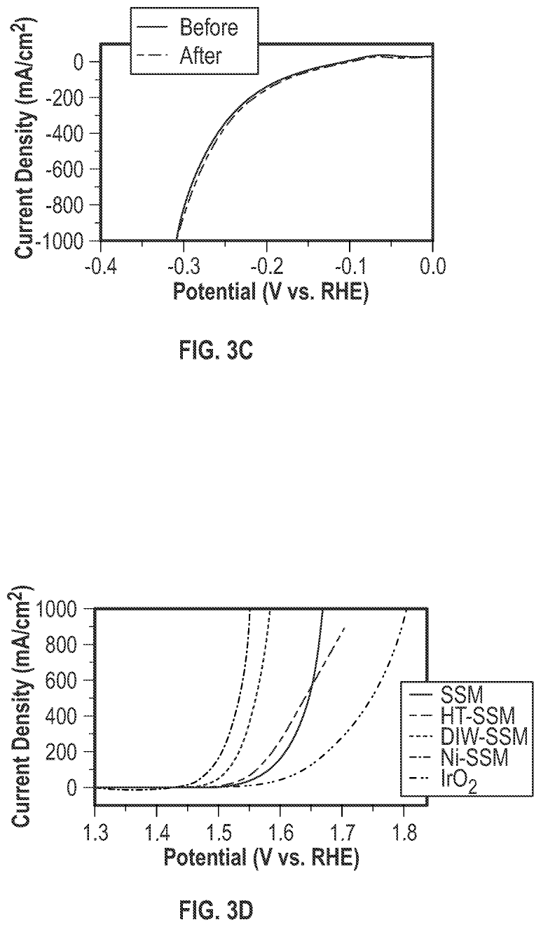

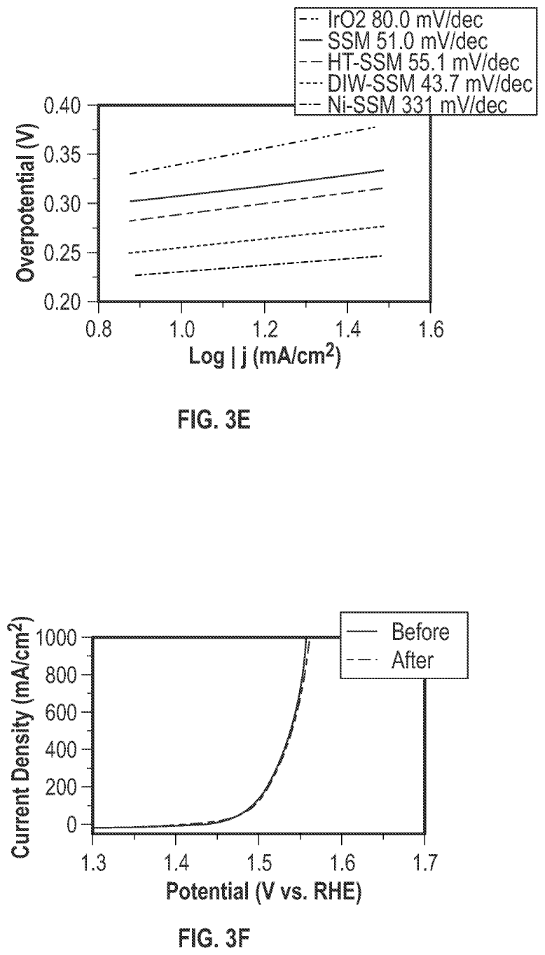

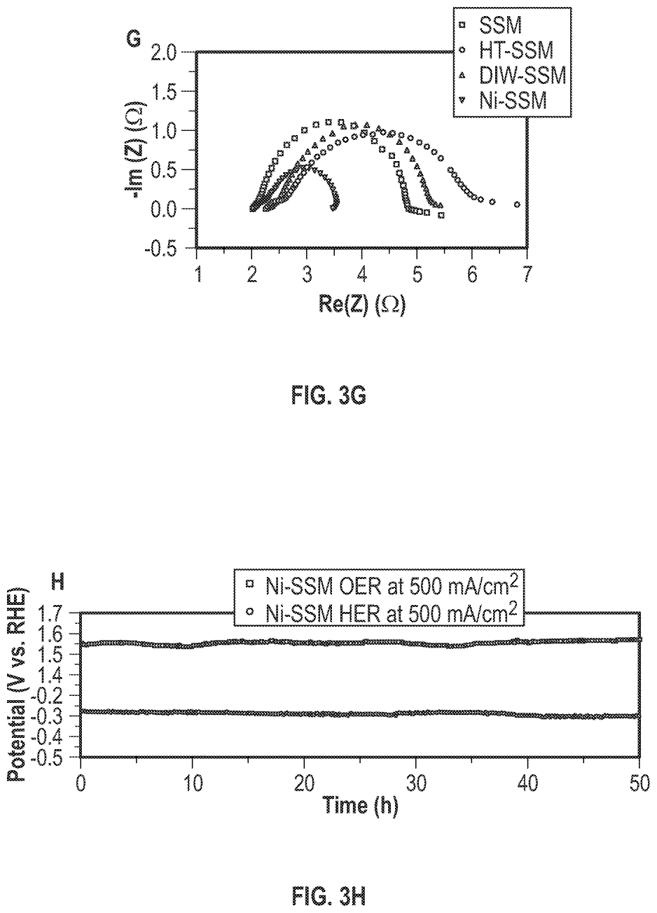

The HER performance was first studied in 1 M KOH at room temperature (~25° C.) and the corresponding results were presented in FIG. 3A. The pristine SSM exhibited a poor HER activity in 1 M KOH, delivering 500 mA/cm² at the overpotential of 530 mV. After the high temperature annealing, the HT-SSM displayed an enhanced HER performance compared to the untreated SSM. After quenched in deionized (DI) water, the activity of DIW-SSM decreased slightly. But when quenched into the Ni(NO₃)₂ solution, the Ni-SSM exhibited further enhanced activity than HT-SSM. The Ni-SSM generated 500 mA/cm² at the overpotential of 271 mV, which was close to the 266 mV of the benchmark Pt/C. The overpotentials of different electrodes at various current densities were complementary. The Tafel slope of Ni-SSM in FIG. 3B showed the smallest value of 39.4 mV/dec among different electrodes, suggesting its quick reaction kinetics. The HER performances before and after 10,000 CV.

OER performances of different electrodes were then systematically investigated to unveil how the activation process affected the OER activity of stainless steel. In FIGS. 3D and 3E, the HT-SSM exhibited a smaller onset potential but higher Tafel slope than SSM. After being quenched in DI water, the onset potential and Tafel slope of DIW-SSM were significantly reduced and when quenched in Ni(NO₃)₂ solution, Ni-SSM delivered the best OER performance among the stainless steel electrodes and the benchmark IrO₂. Specifically, the Ni-SSM required merely 310 mV overpotential to drive 500 mA/cm² and showed a small Tafel slope of 33.1 mV/dec in 1 M KOH. The above results revealed that the OER thermodynamic barrier was reduced but reaction kinetics became more sluggish after the SSM was annealed. When further quenched in DI water, an obvious enhancement can be observed on DIW-SSM. Combining with the XRD results the increasing amount of γ-Fe₂O₃ may explain the enhanced OER activity of DIW-SSM. Then when quenched in Ni(NO₃)₂ solution, the increasing amount of γ-Fe₂O₃ and additional Ni doping together achieved the best activity of Ni-SSM. The OER performances before and after 10,000 CV scans presented in FIG. 3F showed the robustness of Ni-SSM for alkaline OER.

### Example 5

To further investigate the mechanism behind the significantly enhanced electrochemical activity of the activated electrodes, electrochemical impedance spectroscopy (EIS) was measured and the results were provided in FIG. 3G. After quenched in DI water, the DIW-SSM displayed a similar Rct to SSM and, when quenched in Ni(NO₃)₂ solution, the Rct of Ni-SSM further reduced to 1.309Ω. Contact angle test was employed to study the hydrophilic/hydrophobic properties of different electrodes. The untreated SSM was hydrophobic with a contact angle of about 120°. After high temperature annealing, the HT-SSM became hydrophilic and no contact angle could be observed with the DI water dipping on its surface. Similar phenomenon was discovered on DIW-SSM and Ni-SSM, unveiling their hydrophilic characteristics. Electrochemical active surface area (ECSA) was further employed to study how the active surface area and intrinsic activity of stainless steel changed with different treatment. The ECSA increased significantly from 143 to 3450 cm² ECSA/cm² after high temperature annealing. The quenching in DI water and Ni(NO₃)₂ solution did not alter the ECSA obviously. The ECSA results suggested the nanosheet architecture induced by the high temperature annealing substantially increased the active surface area of the stainless steel. The HER and OER turnover frequencies (TOF) were calculated based on previous reports. The Ni-SSM exhibited the highest TOF value among the stainless steel based electrodes for both HER and OER, indicating its outstanding intrinsic activity. Therefore, the increased ECSA and intrinsic activity together attributed to the excellent HER and OER activity of Ni-SSM. Chronopotentiometric (CP) tests were further carried out to study the HER and OER durability over time. As shown in FIG. 3H, the HER and OER performances of Ni-SSM remained stable during the 50 h CP test at 500 mA/cm² in 1 M KOH. The SSM was also quenched in 0.15 M Co(NO₃)₂ and 0.15 M Ni(NO₃)₂ & 0.15 M Co(NO₃)₂ solution to investigate the effect of different metal ion doping. Further, Ni²⁺ doping triggered the largest enhancement on both HER and OER activity.

### Example 6

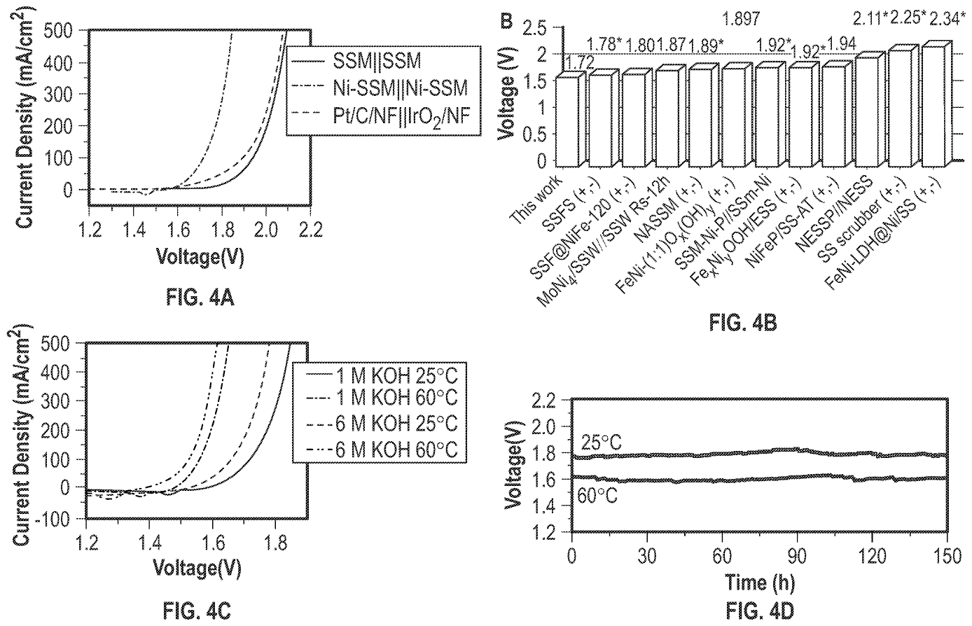

Inspired by the efficient HER and OER performances, Ni-SSM was employed as both anode and cathode for overall water electrolysis. FIG. 4A showed the Ni-SSM produced 500 mA/cm² at 1.846 V in 1 M KOH at 25° C., which was 0.247 V lower than the pristine SSM. The overall water electrolysis performance of Ni-SSM at 100 mA/cm² was further compared with the reported literatures in FIG. 4B. To the best of our knowledge, Ni-SSM delivered the best water electrolysis performance among the stainless steel based electrodes. Under industrial condition, water electrolysis is normally conducted at high temperature (60-80° C.) and high KOH concentration (6-10 M), which will usually increase the performance but raise serious challenge to the stability of catalysts. In FIG. 4C, Ni-SSM exhibited better performance at higher temperature and higher KOH concentration. At 60° C. in 6 M KOH, Ni-SSM required only 1.615 V to generate 500 mA/cm² for overall water electrolysis. In 6 M KOH, CP tests were conducted to study the durability of Ni-SSM at 25 and 60° C. Presented in FIG. 4D, the Ni-SSM maintained its high overall water electrolysis performance during the 150 h test, which revealed its extraordinary stability in the quasi-industry environment.

Finally, similar activation strategy was applied to different substrates such as stainless steel mesh, Ni foam, and Fe foam to investigate the versatility of this strategy. The overall water electrolysis performances in 1 M KOH showed all the substrates exhibited enhanced performance after the activation process. The performances of different electrodes were compared and due to the high specific surface area and suitable element composition of 316 type of stainless steel, Ni-SSM displayed the highest activity among different electrodes.

While aspects of the presently disclosed subject matter have been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the presently disclosed subject matter. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A method of preparing a water electrolysis catalyst, comprising:
subjecting at least a portion of a substrate to a temperature of from about 400° C. to about 1500° C. for a time period of from about 5 seconds to about 30 minutes to form a heat-treated substrate;
contacting the heat-treated substrate with a fluid comprising a transition metal salt under conditions suitable for formation of the water electrolysis catalyst wherein the catalyst has an overpotential ranging from about 100 mV to about 1000 mV in a water electrolysis reaction at a current density of 500 mA/cm².

2. The method of claim 1, wherein the substrate has a surface area ranging from about 100 cm²/g to about 1000 cm²/g.

3. The method of claim 1, wherein the substrate at a current density of 500 mA cm⁻² has an overpotential ranging from about 100 mV to about 1000 mV for a water electrolysis reaction.

4. The method of claim 1, wherein the substrate comprises a metallic alloy, a metallic foil, a metallic stock, a metallic foam, a metallic mat or a metallic mesh or combinations thereof.

5. The method of claim 1, wherein the substrate comprises a nickel mesh, a tungsten mesh, a titanium mesh, an iron mesh, a stainless-steel mesh, a stainless steel mat, or combinations thereof.

6. The method of claim 1, wherein the substrate comprises an Austentitic stainless steel, a ferritic stainless steel, a Martensitic stainless-steel, a duplex (Ferritic-Austenitic) stainless steel, a precipitation hardening stainless-steel or combinations thereof.

7. The method of claim 1, wherein the conditions suitable for formation of the water electrolysis catalyst include an oxidizing atmosphere.

8. The method of claim 1, wherein the fluid comprising a transition metal salt is an aqueous fluid.

9. The method of claim 1, wherein the transition metal salt has the formula MX_{P}, where M is a cationic transition metal, X is an anionic ligand, and p is any number to form a neutral salt.

10. The method of claim 1, wherein the transition metal salt comprises a Group 3 transition metal, a Group 4 transition metal, a Group 5 transition metal, a Group 6 transition metal, a Group 7 transition metal, a Group 8 transition metal, a Group 9 transition metal, a Group 10 transition metal, a Group 11 transition metal, a Group 12 transition metal, or combinations thereof.

11. The method of claim 9, wherein the transition metal has an oxidation state of from +2 to +6.

12. The method of claim 1, wherein the transition metal salt comprises nickel (Ni), iron (Fe), molybdenum (Mo), manganese (Mn) or combinations thereof.

13. The method of claim 9, wherein X is a monoatomic anion or a polyatomic anion.

14. The method of claim 9, wherein X comprises a halide, a carboxylate, a β-diketonate, a hydrocarboxide, a nitrate, a carbonate, a nitrate, or combinations thereof.

15. The method of claim 1, wherein the water electrolysis catalyst has an amount of transition metal on the substrate surface ranging from about 1×10⁻⁶ wt. % to about 10 wt. % based on the total weight of the water electrolysis catalyst.

16. The method of claim 1, wherein the water electrolysis catalyst has a Tafel slope of from about 30 milliVolts per decade (mV/dec) to about 240 mV/dec.

17. A method of preparing a water electrolysis catalyst comprising:
subjecting at least a portion of a substrate to a temperature of from about 400° C. to about 1500° C. for a time period of from about 5 seconds to about 30 minutes to form a heat-treated substrate wherein the substrate is selected from the group consisting of an Austentitic stainless steel, a ferritic stainless steel, a Martensitic stainless steel, a duplex (Ferritic-Austenitic) stainless steel, a precipitation hardening stainless steel and combinations thereof;
contacting the heat-treated substrate with a fluid comprising a transition metal salt under conditions suitable for formation of the water electrolysis catalyst having an overpotential ranging from about 100 mV to about 1000 mV in a water electrolysis reaction at a current density of 500 mA/cm².

18. The method of claim 17, wherein the transition metal salt comprises nickel (Ni), iron (Fe), molybdenum (Mo), manganese (Mn) or combinations thereof.

19. The method of claim 17, wherein the water electrolysis catalyst has an overpotential at a current density of 500 mA/cm² that is increased by equal to or greater than about 10% when compared to the overpotential of the substrate.

20. The method of claim 17, wherein the water electrolysis catalyst has a Tafel slope of from about 30 milliVolts per decade (mV/dec) to about 240 mV/dec.
